(19) United States
(12) Patent Application Publication
(10) Pub. No.: US 2015/0103252 A1
(43) Pub. Date: Apr. 16, 2015

(54) SYSTEM, METHOD, AND COMPUTER PROGRAM PRODUCT FOR GAMMA CORRECTION IN A VIDEO OR IMAGE PROCESSING ENGINE

(71) Applicant: NVIDIA Corporation, Santa Clara, CA (US)

(72) Inventors: Narendra Keshav Rane, Bangalore (IN); Mukesh Chand Agarwal, Bangalore (IN); Sandeep Vangipuram, Bangalore (IN); Satinder Kumar, Chandigarh (IN)

(73) Assignee: NVIDIA Corporation, Santa Clara, CA (US)

(21) Appl. No.: 14/055,831

(22) Filed: Oct. 16, 2013

(51) Int. Cl. G09G 5/06; H04N 9/69

(52) U.S. Cl. CPC G09G 5/06; H04N 9/69; G09G 2340/06
USPC 348/675; 345/601

(57) ABSTRACT

A system and method are provided for generating a gamma adjusted value. The method comprises generating a logarithm space representation of an input value by computing a logarithm of the input value, computing a logarithm space gamma-adjusted value by multiplying the logarithm space representation with a current gamma value, and generating the gamma adjusted value by computing an antilogarithm of the logarithm space gamma-adjusted value.

### FIELD OF THE INVENTION

The present invention relates to digital video or image, and more specifically to gamma correction in a video or image processing engine.

### BACKGROUND

A typical video or image processing engine is configured to receive and process input digital video/image data and generate output digital video/image data. For example, a video processing engine may receive digital video data for multiple gamma-encoded input video streams and composite the input video streams into an output video stream for display or to feed another video/image processing engine. Each input video stream may include a different gamma correction value, requiring the video processing engine to decode each gamma-encoded input video stream into a linear color space prior to performing any image processing operations related to compositing. Such image processing operations may include blending, scaling, color-conversion and the like. The output video stream may require a gamma encoding operation to compensate for a gamma value associated with a display device configured to display the output video stream.

A conventional gamma decoder/encoder comprises a look-up table (LUT) populated with values that map an input value to an output value through a power function that raises the input value to the power of gamma. A video processing engine may be required to receive and process an arbitrarily large number of input video streams, and perform gamma decoding over each of the input video streams. Because each LUT may require a significant amount of die area, conventional video processing engines implement one gamma LUT or two gamma LUTs on-chip, configured to alternate between active and preload modes. Each gamma LUT may be preloaded from a less expensive general purpose memory based on which input video stream is to be processed. The general-purpose memory may comprise an off-chip dynamic random access memory (DRAM).

While continuously preloading a gamma LUT enables the video processing engine to process an arbitrary number of input video streams, this technique also requires additional power consumption and memory bandwidth associated with continually accessing the general-purpose memory. Furthermore, certain video processing engines may perform gamma decoding on a frame tile granularity, requiring a significant number of LUT preload operations to be performed per video frame, per input video stream, resulting in inefficient use of power and memory bandwidth.

Thus, there is a need for addressing this issue and/or other issues associated with the prior art.

### SUMMARY

A system, method, and computer program product are provided for generating a gamma adjusted value. The method comprises generating a logarithm space representation of an input value by computing a logarithm of the input value, computing a logarithm space gamma-adjusted value by multiplying the logarithm space representation with a current gamma value, and generating the gamma adjusted value by computing an antilogarithm of the logarithm space gamma-adjusted value.

### BRIEF DESCRIPTION OF THE DRAWINGS

FIG. 1A illustrates a flow chart of a method for performing a gamma adjustment on an input value, in accordance with one embodiment;

FIG. 1B illustrates a flow chart of a method for generating an output video stream based on two different input video streams, each encoded using different gamma values, in accordance with one embodiment;

FIG. 1C illustrates a gamma function unit, in accordance with a first embodiment;

FIG. 1D illustrates a gamma function unit, in accordance with a second embodiment;

FIG. 1E illustrates a video processing engine based on a gamma function unit, in accordance with one embodiment;

FIG. 2 illustrates a parallel processing unit (PPU), according to one embodiment;

FIG. 3 illustrates the streaming multi-processor of FIG. 2, according to one embodiment;

FIG. 4 is a conceptual diagram of a graphics processing pipeline implemented by the PPU of FIG. 2, in accordance with one embodiment; and

FIG. 5 illustrates an exemplary system in which the various architecture and/or functionality of the various previous embodiments may be implemented.

### DETAILED DESCRIPTION

A technique is provided for implementing a gamma function unit within a video processing engine. The video processing engine may utilize the gamma function unit to efficiently decode a plurality of different video streams using a decoding gamma value per video stream. A different decoding gamma value may correspond to each of the different video streams. A video stream comprising encoded color data generated by gamma-encoding linear color space video data with an encoding gamma value may be decoded to recover the linear color space video data through a second gamma adjustment using a decoding gamma value that corresponds to the reciprocal of the encoding gamma value. This relationship follows because the product of multiplying the encoding gamma value by the decoding gamma value results in a net operation equivalent to raising an input value to the power of one, and any input value raised to the power of one yields the input value. The gamma function unit therefore decodes each of the different video streams to recover the corresponding linear color space video data.

With each of the plurality of different video streams decoded into a consistent linear color space representation, the video processing engine may operate on corresponding decoded linear color space video data according to any technically feasible processing techniques, such as scaling, blending, temporal re-sampling, compositing, and related techniques to generate an output video stream. The output video stream comprises linear color space video data, which may be encoded by the gamma function unit. The gamma function unit is configured to use an encoding gamma value that is appropriate for a target display device. While embodiments of the present invention are described in a context of video frames, persons skilled in the art will understand that the techniques described herein may be applied to any digital images, including digital still images, and synthetic images, such as images or video frames generated by a graphics processing unit.

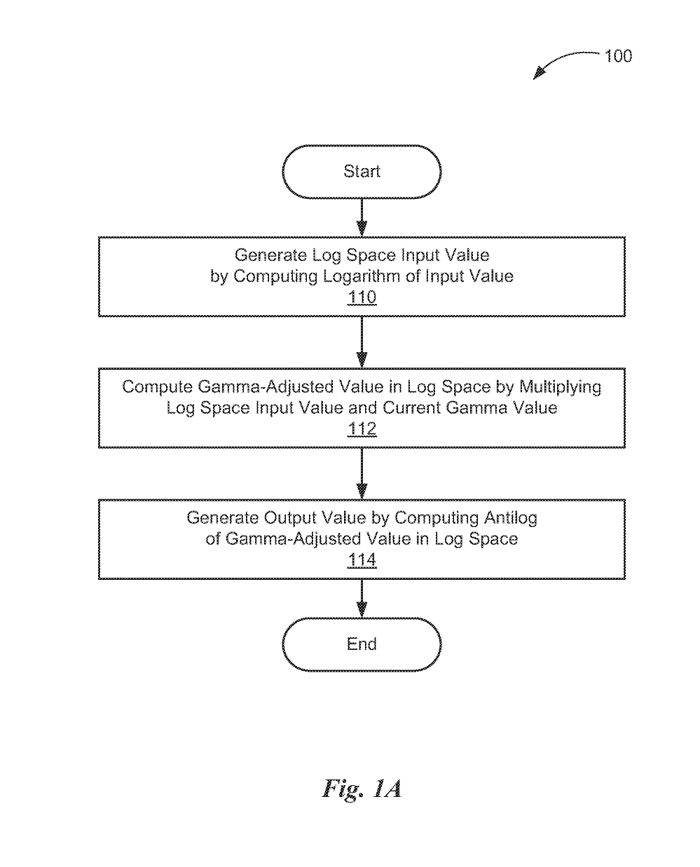

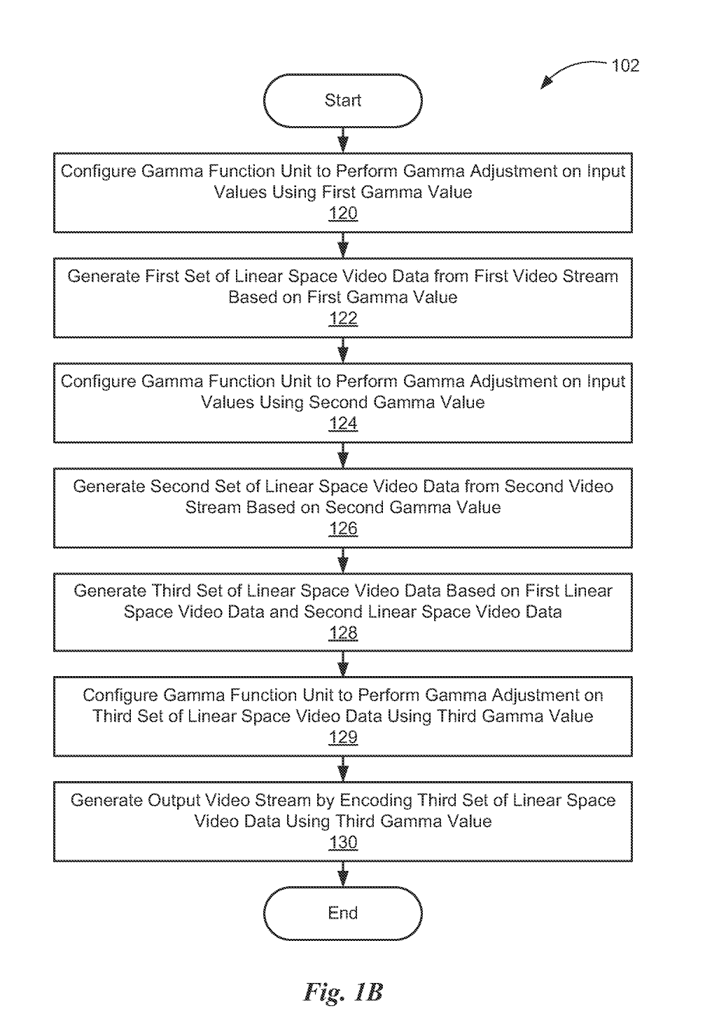

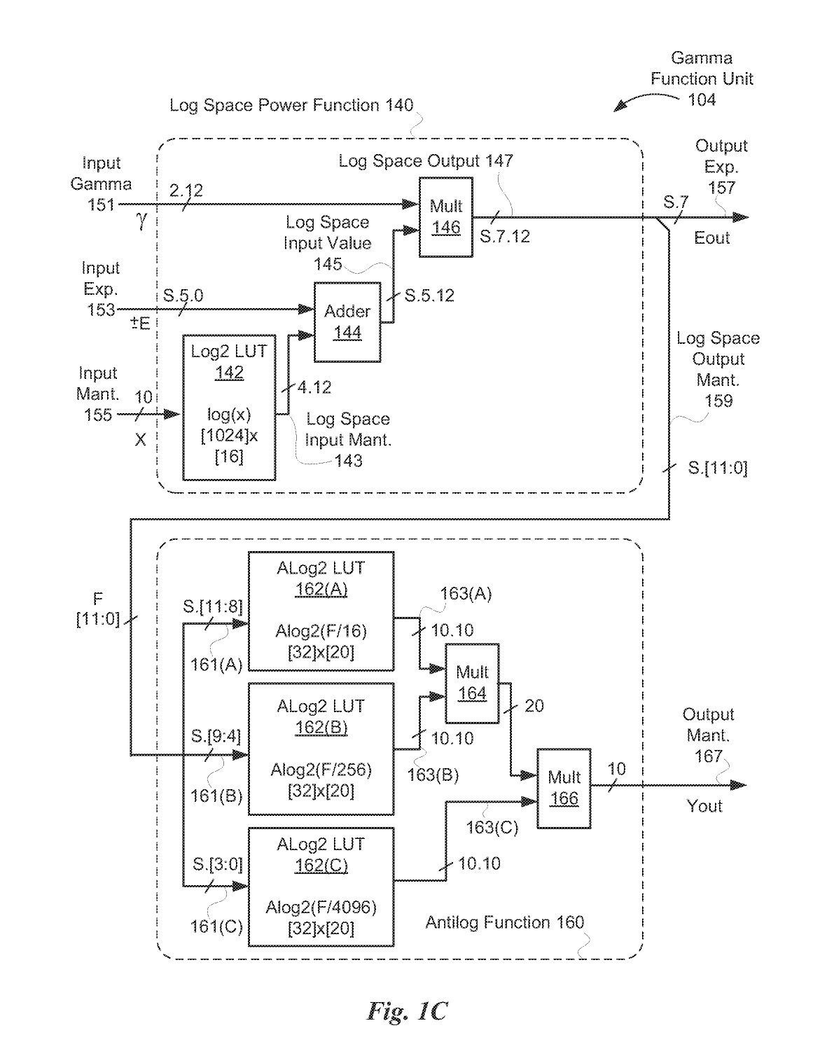

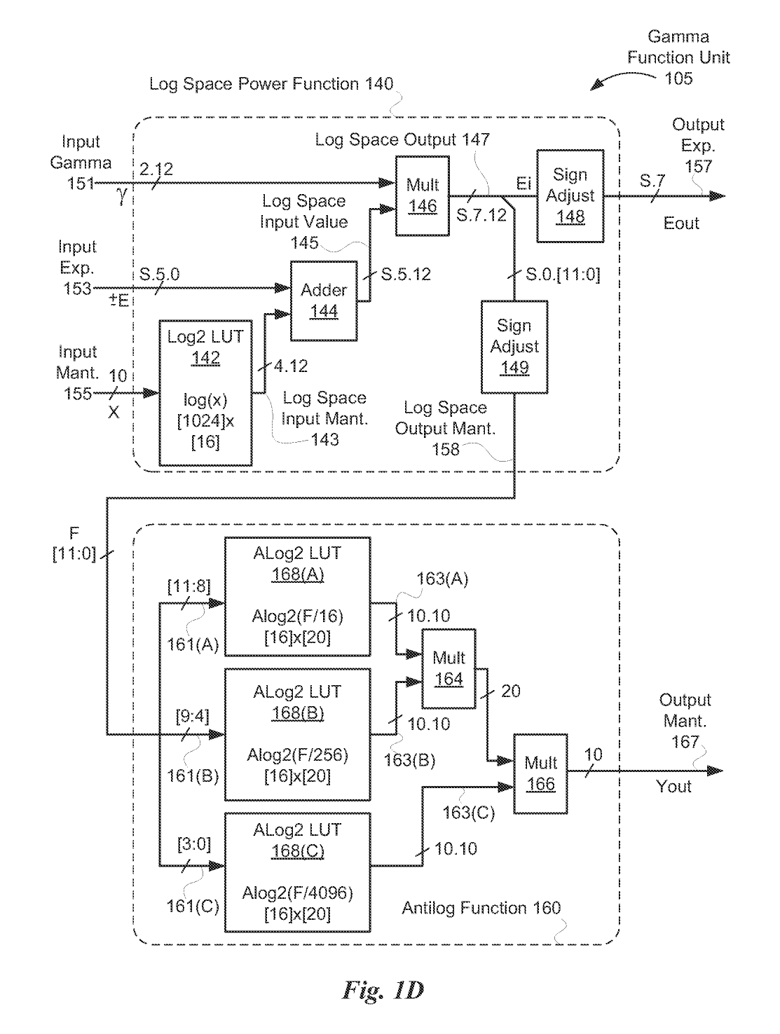

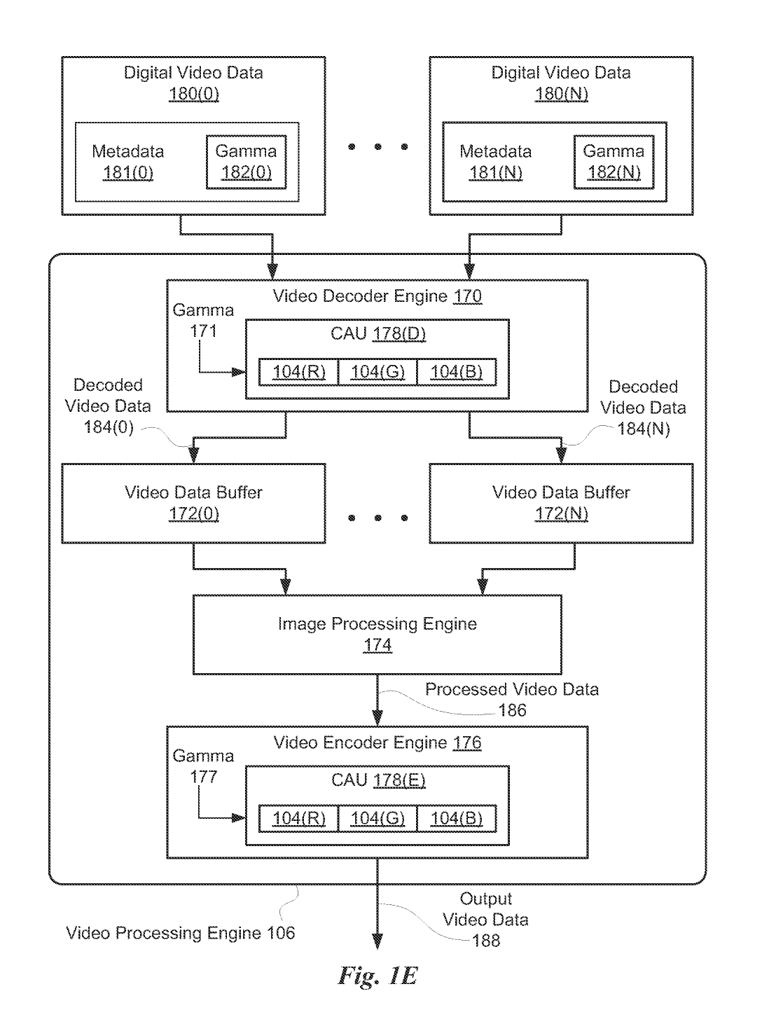

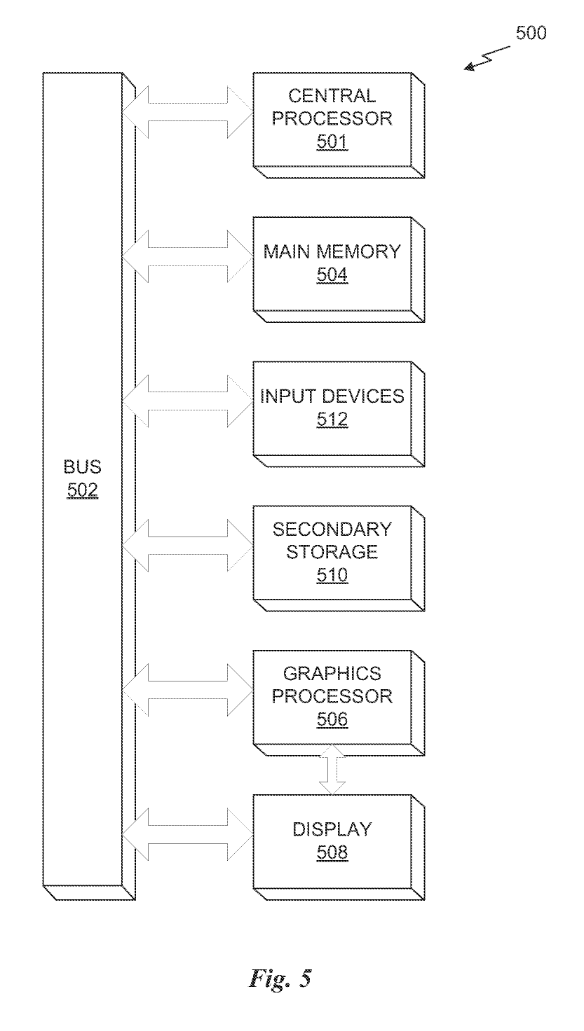

FIG. 1A illustrates a flow chart of a method 100 for performing a gamma adjustment on an input value, in accordance with one embodiment. Although method 100 is described in the context of a gamma function unit, the method 100 may also be performed by a program, custom circuitry, or by a combination of custom circuitry and a program. Furthermore, persons of ordinary skill in the art will understand that any system that performs method 100 is within the scope and spirit of embodiments of the present invention. In one embodiment, method 100 is performed by a gamma function unit, such as gamma function unit 104 of FIG. 1C or gamma function unit 105 of FIG. 1D, implemented within a graphics processing unit (GPU), such as GPU 506 of FIG. 5. The gamma function unit performs a mathematical operation comprising raising an input value to the power of a gamma value. This mathematical operation may be used to decode gamma-encoded video data to recover original linear color space video data as well as encode linear color space video data into gamma-encoded video data.

Method 100 begins in step 110, where the gamma function unit generates a log space (logarithm space) input value by computing a logarithm of an input value. In one embodiment, the log space input value comprises a base-two logarithm of the input value. In step 112, the gamma function unit computes a gamma-adjusted value in log space by multiplying the log space input value by a current gamma value. The current gamma value may correspond to a reciprocal of an encoding gamma value associated with a given input video stream being processed. Alternatively, the current gamma value may correspond to a gamma value associated with a display device, or a standard gamma value for encoding digital video. In one embodiment, the encoding gamma value is recorded in metadata associated with a corresponding video stream. In step 114, the gamma function unit generates an output value by computing an antilogarithm (power function) of the gamma-adjusted value in log space. In one embodiment, the gamma function unit computes the output value by computing a base two antilogarithm of the gamma-adjusted value in log space. As illustrated below in FIGS. 1C and 1D, an antilogarithm function may be implemented as the product of two or more partial antilogarithm values. While method 100 is described with respect to logarithm and antilogarithm functions in base two, any technically feasible logarithm base may be implemented without departing the scope of embodiments of the present invention.

FIG. 1B illustrates a flow chart of a method 102 for generating an output video stream based on two different input video streams, each encoded using different gamma values, in accordance with one embodiment. Although method 102 is described in the context of a video processing engine, the method 102 may also be performed by a program, custom circuitry, or by a combination of custom circuitry and a program. Furthermore, persons of ordinary skill in the art will understand that any system that performs method 102 is within the scope and spirit of embodiments of the present invention. In one embodiment, method 102 is performed by a video processing engine, implemented within a graphics processing unit (GPU), such as GPU 506 of FIG. 5.

Method 102 begins in step 120, where the video processing engine configures a gamma function unit, such as gamma function unit 104 of FIG. 1C or gamma function unit 105 of FIG. 1D, to perform gamma adjustment on input values using a first gamma value associated with a first video stream. In one embodiment, the first gamma value is programmed into a data register associated with the gamma function unit. In one embodiment, the video processing engine retrieves an encoding gamma value from metadata associated with the first video stream and computes the first gamma value as a reciprocal of the encoding gamma value. In step 122, the video processing engine generates a first set of linear space video data from the first video stream based on the first gamma value. In one embodiment, the video processing engine may be configured to decode the first video stream as a sequence of tiles, such as sixteen by sixteen pixel tiles. In one embodiment, the first video stream comprises a red, a green, and a blue color channel, and each color channel is decoded according to the first gamma value. Three independent instances of the gamma function unit may be implemented as a color adjustment unit to provide simultaneous encoding or decoding of the red, green, and blue color channels. Each of the three instances of the gamma function unit may be configured to operate according to a common gamma value. For example, each of the three instances of the gamma function unit should be configured to operate according to the first gamma value.

In step 124, the video processing engine configures the gamma function unit to perform gamma adjustment on input values using a second gamma value, associated with a second video stream. In one embodiment, the color adjustment unit, comprising three instances of the gamma function unit, is configured to perform gamma adjustment on input values using the second gamma value. In step 126, the video processing engine generates a second set of linear space video data from the second video stream based on the second gamma value. In one embodiment, the video processing engine is configured to decode the second video stream as a sequence of tiles. In one embodiment, the second video stream comprises a red, a green, and a blue color channel, and each color channel is decoded according to the second gamma value.

In step 128, the video processing engine generates a third set of linear space video data based on the first linear space video data and the second linear space video data. Generating the third set of linear space video data may include scaling, blending, temporal re-sampling, other compositing operations, or any other technically feasible video processing operations. In step 129, the video processing engine configures the gamma function unit to perform gamma adjustments on the third set of linear space video data using a third gamma value. In step 130, the video processing engine generates an output video stream by encoding the third set of linear space video data using a third gamma value. In one embodiment, the third gamma value comprises a gamma value associated with a display device, configured to display the output video stream.

In one embodiment, the first video stream comprises digital video data stored within a mass storage device, such as a hard disk drive or flash drive. In an alternative embodiment, the first video stream comprises a digital video data streamed through a network connection from a streaming data server. In each case, the first video stream may be buffered in general purpose memory, such as DRAM coupled to a GPU, or DRAM coupled to a system-on-a-chip (SoC) comprising the video processing engine.

FIG. 1C illustrates a gamma function unit 104, in accordance with one embodiment. The gamma function unit 104 includes a log space power function 140 and an antilogarithm function 160. In one embodiment, the gamma function unit 104 is configured to receive a fixed-point gamma value as input gamma 151, and a floating-point input value comprising an input mantissa 155 and an input exponent 153. In one embodiment, the input exponent 153 comprises a signed integer value. However, any technically feasible signed integer representation may be implemented. The gamma function unit 104 is further configured to generate a floating-point output value comprising output exponent 157 and output mantissa 167. The output value is assigned a value corresponding to the input value raised to the power of the value of input gamma 151.

In one embodiment, the log space power function 140 comprises a base-two logarithm (Log2) look-up table (LUT) 142, an adder 144, and a multiplier 146. The Log2 LUT 142 is configured to generate a log space input mantissa 143 corresponding to a base-two logarithm of input mantissa 155. In one embodiment, Log2 LUT 142 is implemented as a read-only memory (ROM). Any technically feasible technique may implement the ROM, such as via programming, or interconnect layer (metal, poly, etc.) programming. The input mantissa 155 serves as a look-up index for Log2 LUT 142, and the log space input mantissa 143 is assigned a value from an entry within Log2 LUT 142 selected by the index. Adder 144 is configured to generate a log space input value 145 by adding log space input mantissa 143 to input exponent 153. The log space input value 145 is a log space representation of the floating-point input value. Multiplier 146 is configured to generate log space output 147 by multiplying input gamma 151 by the log space input value 145. Multiplier 146 computes a power function associated with gamma adjustment in log space. Log space output value 147 is a log space representation of the floating-point input value raised to the power of the value of input gamma 151.

Output exponent 157 is a signed integer and fractional value corresponding to an exponent for the resulting output value. A fractional part of Log space output mantissa 159 is converted to an output mantissa 167 by the antilogarithm function 160. The output mantissa 167 and the integer part of output exponent 157 together form a floating-point representation of the resulting output value.

In certain embodiments, the antilogarithm function 160 comprises one or more base-two antilogarithm look-up tables, each configured to generate a partial antilogarithm result by performing an antilogarithm function on a portion of the log space output mantissa 159. Partial antilogarithm results may be multiplied together to generate an overall antilogarithm result comprising output mantissa 167. In one embodiment, one antilogarithm LUT implements a complete antilogarithm function on the log space mantissa output 159. In such an embodiment, the partial antilogarithm result is identical to a complete antilogarithm result. No multiplier is required, however the one antilogarithm LUT may require a relatively large and costly die area in practical implementations. For example, if the log space output mantissa 159 comprises one sign bit and twelve mantissa bits, then the one antilogarithm. LUT would require four-thousand ninety-six entries, each comprising an appropriate bit-width.

In one embodiment, shown here, the antilogarithm of log space output mantissa 159 is computed as the product of three partial antilogarithm operations, illustrated to Equation 1:

X_{S·(A+B+C)}=X^{S·A}·X^{S·B}·X^{S·C} (1)

Log space antilogarithm output mantissa 159 corresponds to the term “S·(A+B+C” and the output mantissa 167 comprises the term XS·A+B+C. The sign of log space antilogarithm mantissa 159 is given as “S” and may be implemented as a sign bit. Each term A, B, C corresponds to a portion of a binary vector representation of log space antilogarithm mantissa 159. Three different LUTs comprising ALog2 LUT 162(A), ALog2 LUT 162(B), and ALog2 LUT 162(C) are configured to compute the partial antilogarithm terms X^{S·A}, X^{S·B}, or X^{S·C}, respectively. Multipliers 164 and 166 compute the two multiplication operations shown in Equation 1. In an implementation where log space output mantissa 159 comprises one sign bit and twelve mantissa bits, each ALog2 LUT 162 includes thirty-two entries (one sign bit, and four bits for each of A, B, and C terms), or ninety-six entries in total. Ninety-six total LUT entries compares favorably to a one antilogarithm LUT implementation requiring four-thousand ninety-six. Persons skilled in the art will recognize that other configurations involving different numbers of partial antilogarithm terms may be advantageously implemented without departing the scope and spirit of the present invention. In one embodiment, each ALog2 LUT 162 is implemented as a read-only memory (ROM). Any technically feasible technique may implement the ROM, such as via programming, or interconnect layer (metal, poly, etc.) programming.

In one embodiment, input gamma 151 is a fixed-point number that includes two integer and twelve fraction bits. Input exponent 153 includes a sign bit and five exponent bits. Input mantissa 155 comprises ten mantissa bits. Log space input mantissa 143 is a fixed-point number that includes four integer bits and twelve fraction bits. Log space input value 145 is a fixed-point number that includes a sign bit, copied from input exponent 153, four integer bits, and twelve fraction bits. Log space output 147 is a signed, fixed-point number that includes a sign bit, five integer bits, and twelve fraction bits. Output exponent 157 is a signed integer that includes a sign bit, copied from the sign bit comprising log space output 147, and five integer bits, copied from the five integer bits comprising log space output 147. Log space output mantissa 159 is a signed fraction, comprising a sign bit, copied from the sign bit comprising log space output 147, and the twelve fraction bits comprising log space output 147. LUT input 161(A) includes the sign bit and the four most significant bits [11:8] of log space output mantissa 159. LUT input 161(B) includes the sign bit and the four middle bits [7:4] of log space output mantissa 159. LUT input 161(C) includes the sign bit and the four least significant bits [3:0] of log space output mantissa 159. Each LUT input 161 serves as a look-up index for a corresponding ALog2 LUT 162. Each ALog2 LUT 162 is configured to generate an antilogarithm base two (power of two) function of their respective input range. Each antilogarithm LUT output 163 comprises a fixed-point number comprising ten integer bits and ten fraction bits. Output mantissa 167 includes the ten most significant bits from multiplier 166. Other embodiments may include more or fewer integer or fraction bits in each respective input, output, or intermediate term. Other embodiments may also include more or fewer ALog2 LUTs 162.

FIG. 1D illustrates a gamma function unit 105, in accordance with a second embodiment. As shown, gamma function unit 105 is configured according to gamma function unit 104. However, gamma function unit 105 also includes sign adjustment units 148, 149. Gamma function unit 105 also replaces ALog2LUTs 162, configured to implement signed antilogarithm functions, with ALog2 LUTs 168, configured to implement unsigned antilogarithm functions. ALog2LUTs 168 may be half as large as ALog2LUTs 162 because there is no need to implement different lookup values based on sign. In one embodiment, each ALog2 LUT 168 is implemented as a read-only memory (ROM). The addition of sign adjustment units 148, 149 advantageously provides for a signed to unsigned translation in the log space output mantissa 158, thereby enabling the use of smaller antilogarithm LUTs. In one embodiment, adjustment unit 148 implements function 2 on the integer part of the exponent, illustrated below:

Eₒᵤₜ=(Eᵢₙ<0)?Eᵢₙ−1:Eᵢₙ (2)

In such an embodiment, sign adjustment unit 149 implements function 3 on the fractional part of the exponent, illustrated below:

Eₒᵤₜ=(Eᵢₙ<0)?1−Eᵢₙ:Eᵢₙ (3)

In each case, gamma function units 104, 105 implement a gamma function according to equation 4, illustrated below:

(X·2^{E})^{γ}=Yout·2^{Eout} (4)

FIG. 1E illustrates a video processing engine 106 based on a gamma function unit, in accordance with one embodiment. One exemplary gamma function unit 104 is illustrated in FIG. 1C. Another exemplary gamma function unit 105 is illustrated in FIG. 1D. As shown, video processing engine 106 includes a video decoder engine 170, an image processing engine 174, and a video encoder engine 176. The video decoder engine 170 is configured to receive one or more sets of digital video data 180, Each set of digital video data 180(0) through 180(N) includes frames of video information as well as metadata 181 comprising an encoding gamma value 182. The encoding gamma value 182 indicates a gamma value used to encode the frames of video information. Video decoder engine 170 may implement any technically feasible video decoding techniques, including, without limitation, standard suites of techniques known in the art as MPEG (moving pictures experts group), QuickTime®, and the like. One aspect of video decoding required in many such techniques involves translating pixel intensity values from a gamma-encoded pixel value to a linear space pixel value.

In one embodiment, a color adjustment unit (CAU) 178(D) is configured to perform gamma decoding adjustments on decompressed pixel values within the video decoder engine 170. The CAU 178(D) comprises three instances 104(R), 104(G), 104(G) of gamma function unit 104 of FIG. 1C. In an alternative embodiment, instances 104(R), 104(G), 104(G) implement gamma function unit 105 of FIG. 1D. Each one of the three instances 104(R), 104(G), 104(G) is configured to operate separately on one of three color channels (red, green, and blue) associated with a pixel value. Each of the three instances uses decoding gamma value 171. A reciprocal of a given gamma value 182 may be used as decoding gamma value 171 to decode frames of video information associated with a given set of digital video data 180. In certain embodiments, two or more instances of the CAU 178(D) may be implemented within the video decoder engine 170 for higher throughput. In an alternative embodiment, one instance of gamma function unit 104 may be shared over red, green, and blue color channels for reduced. die area in applications requiring lower throughput. The CAU 178(D) may be configured to operate on a given set of digital video data 180 by setting the decoding gamma value 171, a procedure that may be conducted as a single register write operation executed in one or a small number of processing cycles. The register write operation may be significantly more efficient than loading a gamma LUT used in conventional systems for decoding gamma. Loading the gamma LUT is a procedure that typically requires retrieving thousands of bytes of data from an external memory device over thousands of processing cycles more than once per frame of video information.

In one embodiment, video decoder engine 170 generates decoded video data 184 corresponding set of digital video data 180 and writes the decoded video data 184 into a corresponding video data buffer 172. The video data buffer 172 may implement any technically feasible buffering technique. In certain embodiments, whole frames of video information are stored in each video data buffer 172, which may comprise a buffer allocated within an external memory. An image processing engine 174 is configured to perform image processing operations on one or more sets of decoded video data 184 retrieved from a corresponding video data buffer 172 to generate a set of processed video data 186. Image processing engine 174 may be configured to generate the set of processed video data 186 by combining two or more different sets of decoded video information 184, by performing, without limitation, scaling, blending, temporal re-sampling, other compositing operations, or any other technically feasible video processing operations on the two or more different sets of decoded video information 184. A video encoder engine 176 is configured to generate a set of output video data 188 by encoding the processed video data 186 for storage, display, or a combination thereof. In one embodiment, video encoder engine 176 comprises a CAU 178(E), configured to perform gamma adjustment using an encoding gamma value 177 on pixel values associated with processed video data 186. The encoding gamma value 177 may be associated with a display device, so that the output video data 188 is displayed properly on the display device. In one embodiment, CAU 178(D) and CAU 178(E) comprise the same CAU unit.

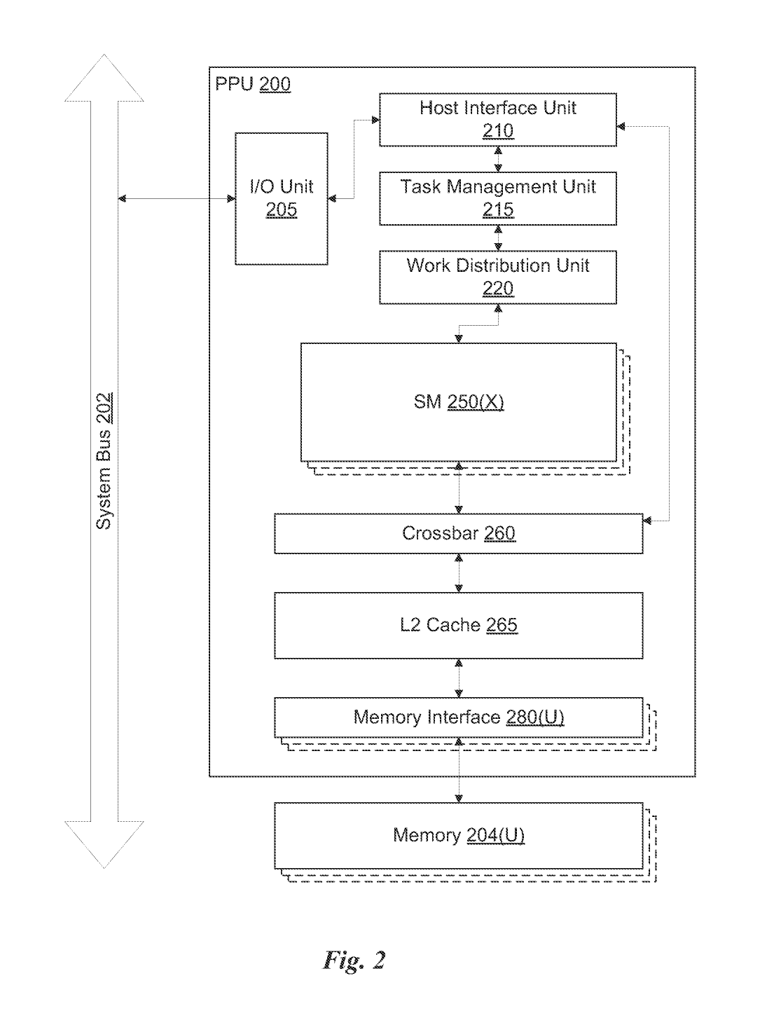

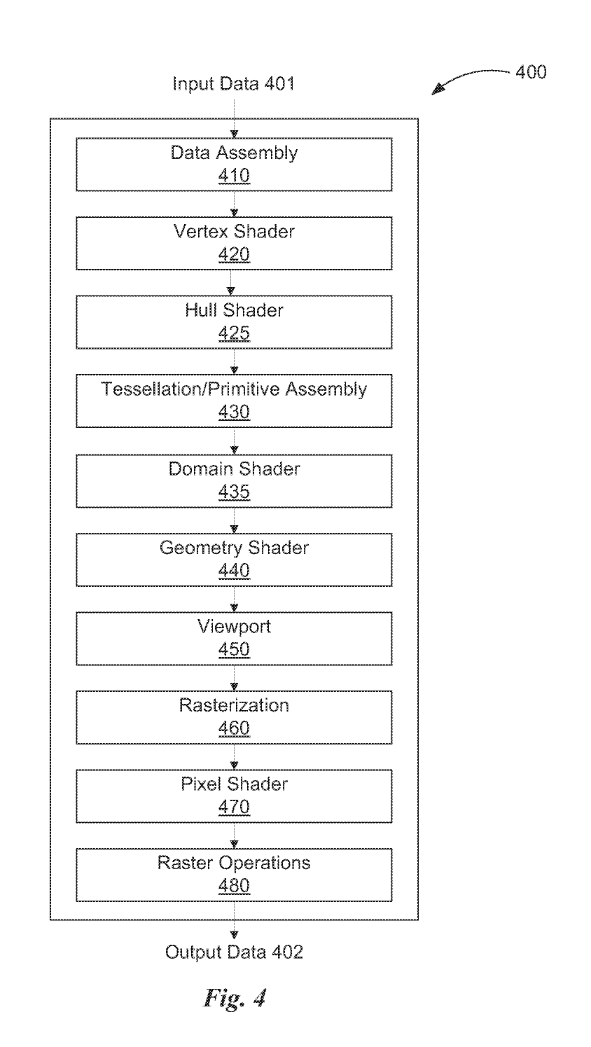

In one embodiment, a CAU is implemented within a streaming multi-processor 250 illustrated below in FIG. 2, enabling efficient gamma adjustment operations performed in conjunction with thread execution within a parallel processing unit 200. In other embodiments, video processing engine 106 is implemented within raster operations unit 480 of FIG. 4. In still other embodiments, video processing engine 106 is implemented as an independent execution unit within a graphics processing unit, such as graphics processor 506 of FIG. 5.

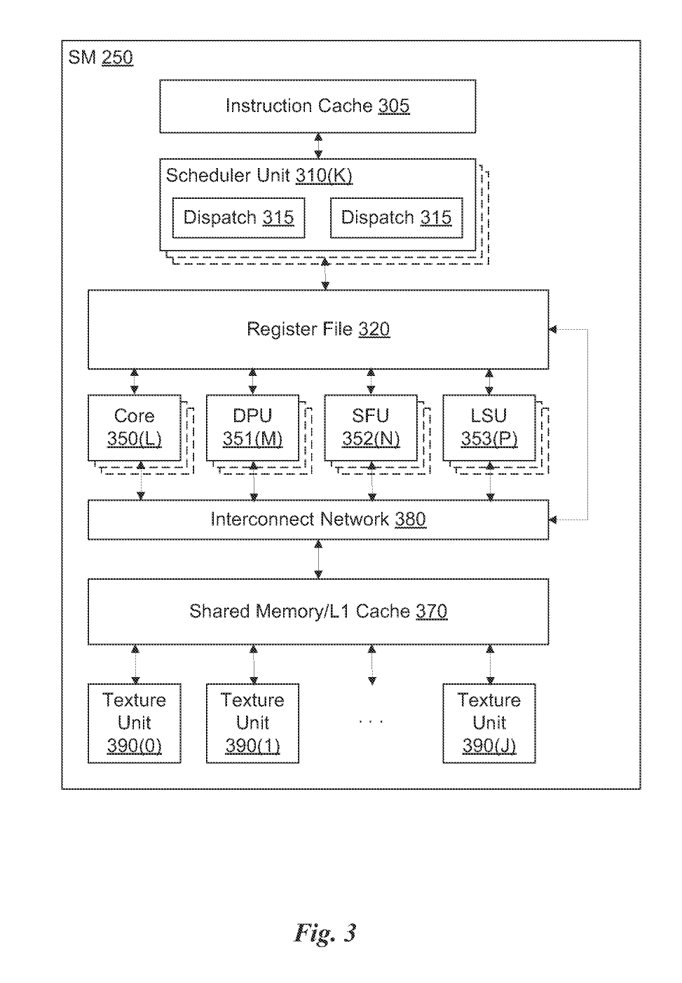

FIG. 2 illustrates a parallel processing unit (PPU) 200, according to one embodiment. While a parallel processor is provided herein as an example of the PPU 200, it should be strongly noted that such processor is set forth for illustrative purposes only, and any processor may be employed to supplement and/or substitute for the same. In one embodiment, the PPU 200 is configured to execute a plurality of threads concurrently in two or more streaming multi-processors (SMs) 250. A thread (i.e., a thread of execution) is an instantiation of a set of instructions executing within a particular SM 250. Each SM 250, described below in more detail in conjunction with FIG. 3, may include, but is not limited to, one or more processing cores, one or more load/store units (LSUs), a level-one (L1) cache, shared memory, and the like.

In one embodiment, the PPU 200 includes an input/output (I/O) unit 205 configured to transmit and receive communications (i.e., commands, data, etc.) from a central processing unit (CPU) (not shown) over the system bus 202. The I/O unit 205 may implement a Peripheral Component interconnect Express (PCIe) interface for communications over a PCIe bus. In alternative embodiments, the I/O unit 205 may implement other types of well-known bus interfaces.

The PPU 200 also includes a host interface unit 210 that decodes the commands and transmits the commands to a task management unit 215 or other units of the PPU 200 (e.g., memory interface 280) as the commands may specify. The host interface unit 210 is configured to route communications between and among the various logical units of the PPU 200.

In one embodiment, a program encoded as a command stream is written to a buffer by the CPU. The buffer is a region in memory, e.g., memory 204 or system memory, that is accessible (i.e., read/write) by both the CPU and the PPU 200. The CPU writes the command stream to the buffer and then transmits a pointer to the start of the command stream to the PPU 200. The host interface unit 210 provides the task management unit (TMU) 215 with pointers to one or more streams. The TMU 215 selects one or more streams and is configured to organize the selected streams as a pool of pending grids. The pool of pending grids may include new grids that have not yet been selected for execution and grids that have been partially executed and have been suspended.

A work distribution unit 220 that is coupled between the TMU 215 and the SMs 250 manages a pool of active grids, selecting and dispatching active grids for execution by the SMs 250. Pending grids are transferred to the active grid pool by the TMU 215 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 220. In addition to receiving grids from the host interface unit 210 and the work distribution unit 220, the TMU 215 also receives grids that are dynamically generated by the SMs 250 during execution of a grid. These dynamically generated grids join the other pending grids in the pending grid pool.

In one embodiment, the CPU executes a driver kernel that implements an application programming interface (API)that enables one or more applications executing on the CPU to schedule operations for execution on the PPU 200. An application may include instructions (i.e., API calls) that cause the driver kernel to generate one or more grids for execution. In one embodiment, the PPU 200 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 200 comprises X SMs 250(X). For example, the PPU 200 may include 15 distinct SMs 250. Each SM 250 is multi-threaded and configured to execute a plurality of threads (e.g., 32 threads) from a particular thread block concurrently. Each of the SMs 250 is connected to a level-two (L2) cache 265 via a crossbar 260 (or other type of interconnect network). The L2 cache 265 is connected to one or more memory interfaces 280. Memory interfaces 280 implement 16, 32, 64, 128-bit data buses, or the like, for high-speed data transfer. In one embodiment, the PPU 200 comprises U memory interfaces 280(U), where each memory interface 280(U) is connected to a corresponding memory device 204(11). For example, PPU 200 may be connected to up to six memory devices 204, such as graphics double-data-rate, version 5, synchronous dynamic random access memory (GDDR5 SDRAM).

In one embodiment, the PPU 200 implements a multi-level memory hierarchy. The memory devices 204 may be located off-chip in SDRAM coupled to the PPU 200. Data from the memory devices 204 may be fetched and stored in the L2 cache 265, which is located on-chip and is shared between the various SMs 250. In one embodiment, each of the SMs 250 also implements an L1 cache. The L1 cache may be implemented as private memory that is dedicated to a particular SM 250. Each of the L1 caches is coupled to the shared L2 cache 265. Data from the L2 cache 265 may be fetched and stored in each of the L1 caches for processing in the functional units of the SMs 250.

In one embodiment, the PPU 200 comprises a graphics processing unit (GPU). The PPU 200 is configured to receive commands that specify shades programs for processing graphics data. Graphics data may be defined as a set of primitives such as points, lines, triangles, quads (rectangles), triangle strips, and the like. Typically, a primitive includes data that specifies a number of vertices for the primitive (e.g., in a model-space coordinate system) as well as attributes or rendering parameters associated with each vertex of the primitive. Rendering parameters may include one of more of position, color, surface normal vector, texture coordinates, etc. The PPU 200 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and rendering parameters) to memory, such as system memory associated with the CPU or memory devices 204. The model data defines each of the objects that may be visible on a display. The application then makes an API call to the driver kernel that requests the model data to be rendered and displayed. The driver kernel reads the model data and writes commands to a buffer to perform one or more operations to process the model data. The commands may encode different shader programs including one or more of a vertex shader, hull shader, geometry shader, pixel shader, etc. For example, the 215 may configure one or more SMs 250 to execute a vertex shader program that processes a number of vertices defined by the model data. In one embodiment, the TMU 215 may configure different SMs 250 to execute different shader programs concurrently. For example, a first subset of SMs 250 may be configured to execute a vertex shader program while a second subset of SMs 250 may be configured to execute a pixel shader program. The first subset of SMs 250 processes vertex data to produce processed vertex data and writes the processed vertex data to the L2 cache 265 and/or the memory 204. After the processed vertex data is rasterized (i.e., transformed from three-dimensional data into two-dimensional data in screen-space) to produce fragment data, the second subset of SMs 250 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 200 may be included in a desktop computer a laptop computer, a tablet computer, a smart-phone (e.g., a wireless, hand-held device), personal digital assistant (PDA), a digital camera, a hand-held electronic device, and the like. In one embodiment, the PPU 200 is embodied on a single semiconductor substrate. In another embodiment, the PPU 200 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 200 may be included on a graphics card that includes one or more memory devices 204 such as GDDR5 SDRAM. The graphics card may be configured to interface with a PCIe slot on a motherboard of a desktop computer that includes, e.g., a northbridge chipset and a southbridge chipset, In yet another embodiment, the PPU 200 may be an integrated graphics processing unit (iGPU) included in the chipset (i.e., Northbridge) of the motherboard.

FIG. 3 illustrates the streaming multi-processor 250 of FIG. 2, according to one embodiment. As shown in FIG. 3, the SM 250 includes an instruction cache 305, one or more scheduler units 310, a register file 320, one or more processing cores 350, one or more double precision units (DPUs) 351, one or more special function units (SFUs) 352, one or more load/store units (LSUs) 353, an interconnect network 380, a shared memory/L1 cache 370, and one or more texture units 390.

As described above, the work distribution unit 220 dispatches active grids for execution on one or more SMs 250 of the PPU 200. The scheduler unit 310 receives the grids from the work distribution unit 220 and manages instruction scheduling for one or more thread blocks of each active grid. The scheduler unit 310 schedules threads for execution in groups of parallel threads, where each group is called a warp. In one embodiment, each warp includes 32 threads. The scheduler unit 310 may manage a plurality of different thread blocks, allocating the thread blocks to warps for execution and then scheduling instructions from the plurality of different warps on the various functional units (i.e., cores 350, DPUs 351, SFUs 352, and LSUs 353) during each clock cycle.

In one embodiment, each scheduler unit 310 includes one or more instruction dispatch units 315. Each dispatch unit 315 is configured to transmit instructions to one or more of the functional units. In the embodiment shown in FIG. 3, the scheduler unit 310 includes two dispatch units 315 that enable two different instructions from the same warp to be dispatched during each clock cycle. In alternative embodiments, each scheduler unit 310 may include a single dispatch unit 315 or additional dispatch units 315.

Each SM 250 includes a register file 320 that provides a set of registers for the functional units of the SM 250. In one embodiment, the register file 320 is divided between each of the functional units such that each functional unit is allocated a dedicated portion of the register file 320. In another embodiment, the register file 320 is divided between the different warps being executed by the SM 250. The register file 320 provides temporary storage for operands connected to the data paths of the functional units.

Each SM 250 comprises L processing cores 350. In one embodiment, the SM 250 includes a large number (e.g., 192, etc.) of distinct processing cores 350. Each core 350 implements a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 250 also comprises M DPUs 351 that implement double-precision floating point arithmetic, N SFUs 352 that perform special functions (e.g., copy rectangle, pixel blending operations, and the like), and P LSUs 353 that implement load and store operations between the shared memory/L1 cache 370 and the register file 320. In one embodiment, the SM 250 includes 64 DPUs 351, 32 SFUs 352, and 32 LSUs 353.

Each SM 250 includes interconnect network 380, configured to connect each of the functional units to the register file 320 and the shared memory/L1 cache 370. In one embodiment, the interconnect network 380 is a crossbar that can be configured to connect any of the functional units to any of the registers in the register file 320 or the memory locations in shared memory/L1 cache 370.

In one embodiment, the SM 250 is implemented within a GPU. In such an embodiment, the SM 250 comprises J texture units 390. The texture units 390 are configured to load texture maps (i.e., a 2D array of texels) from the memory 204 and sample the texture maps to produce sampled texture values for use in shader programs. The texture units 390 implement texture operations such as anti-aliasing operations using mip-maps (i.e., texture maps of varying levels of detail). In one embodiment, the SM 250 includes 16 texture units 390.

The PPU 200 described above may be configured to perform highly parallel computations much faster than conventional CPUs. Parallel computing has advantages in graphics processing, data compression, biometrics, stream processing algorithms, and the like.

FIG. 4 is a conceptual diagram of a graphics processing pipeline 400 implemented by the PPU 200 of FIG. 2, in accordance with one embodiment. The graphics processing pipeline 400 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 400 receives input data 401 that is transmitted from one stage to the next stage of the graphics processing pipeline 400 to generate output data 402. In one embodiment, the graphics processing pipeline 400 may represent a graphics processing pipeline defined by the OpenGL® API or by DirectX 11® by MICROSOFT.

As shown in FIG. 4, the graphics processing pipeline 400 comprises a pipeline architecture that includes a number of stages. The stages include, but are not limited to, a data assembly stage 410, a vertex shader stage 420, a hull shader stage 425, a tessellation/primitive assembly stage 430, a domain shader stage 435, a geometry shader stage 440, a viewport transform stage 450, a rasterization stage 460, a pixel shader stage 470, and a raster operations stage 480. In one embodiment, the input data 401 comprises commands that configure the processing units to implement the stages of the graphics processing pipeline 400 and high-order geometric primitives to be processed by the stages. The output data 402 may comprise pixel data (i.e., color data) that is copied into a frame buffer or other type of surface data structure in a memory (e.g., memory 204). The SMs 250 may be configured by shader program instructions to function as one or more of the shader stages (e.g., vertex, hull, domain, geometry, and pixel shaders).

The data assembly stage 410 receives the input data 401 that specifies vertex data for high-order graphics geometry. The data assembly stage 410 collects the vertex data defining the high-order graphics geometry in a temporary storage or queue, such as by receiving a command from the host processor that includes a pointer to a buffer in a memory system 405 and reading the vertex data from the buffer. In one embodiment, the memory system 405 may include one or more of the memory 204, the L2 cache 265, and the shared memory/L1 cache 370. The vertex data is then transmitted to the vertex shader stage 420 for processing.

The vertex shader stage 420 processes vertex data by performing a set of operations (i.e., a vertex shader or a program) once for each of the vertices. Vertices may be, e.g., specified as a 4-coordinate vector associated with one or more vertex attributes. The vertex shader stage 420 may manipulate properties such as position, color, texture coordinates, and the like. In other words, the vertex shader stage 420 performs operations on the vertex coordinates or other vertex attributes associated with a vertex. Such operations commonly including lighting operations (i.e., modifying color attributes for a vertex) and transformation operations (i.e., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shader stage 420 generates transformed vertex data that is transmitted to the hull shader stage 425.

Conventional graphics processing pipelines transmit the transformed vertex data between different stages through a set of pipeline registers or a dedicated FIFO buffer. As shown in FIG. 4, the vertex shader stage 420 may pass the vertex data directly to the hull shader stage 425.

The tessellation/primitive assembly stage 430 receives the control points passed from the hull shader stage 425 and tessellates the patches into geometric primitives for processing by the domain shader stage 435. For example, the tessellation/primitive assembly stage 430 may be configured to group every three consecutive vertices as a geometric primitive (i.e., a triangle) for transmission to the domain shader stage 435. In some embodiments, specific vertices may be reused for consecutive geometric primitives (e.g., two consecutive triangles in a triangle strip may share two vertices). After tessellation, the amount of data representing graphics geometry received as input data 401 may be significantly larger because the granularity of the geometry typically becomes finer, requiring more data, as the geometry is processed by the different stages of the graphics processing pipeline.

The domain shader stage 435 computes vertex position attributes for each tessellated vertex. The vertex position attributes generated by the domain shader stage 435 may be passed directly to the geometry shader stage 440 or may be passed to the geometry shader stage 440. The geometry shader stage 440 processes geometric primitives by performing a set of operations (i.e., a geometry shader program) on the geometric primitives. Geometry shading operations may generate one or more geometric primitives from each geometric primitive. In other words, the geometry shader stage 440 may subdivide each geometric primitive into a finer mesh of two or more geometric primitives for processing by the rest of the graphics processing pipeline 400. The geometry shader stage 440 transmits resulting geometric primitives (e.g., points, lines triangles, and the like) to the viewport stage 450.

The viewport stage 450 performs a viewport transform, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (i.e., discarded) because the geometric primitive will not contribute to the final rendered scene. Any geometric primitive that is partially inside the viewing frustum and partially outside the viewing frustum may be clipped (i.e., transformed into a new geometric primitive that is enclosed within the viewing frustum. Furthermore, geometric primitives may each be scaled based on depth of the viewing frustum. All potentially visible geometric primitives are then transmitted to the rasterization stage 460.

The rasterization stage 460 converts the 3D geometric primitives into 2D fragments. The rasterization stage 460 may be configured to utilize the vertices of the geometric primitives to setup a set of plane equations from which various attributes can be interpolated. The rasterization stage 460 may also compute a coverage mask for a plurality of pixels that indicates whether one or more sample locations for a pixel intercept the geometric primitive. In one embodiment, z-testing may also be performed to determine if the geometric primitive is occluded by other geometric primitives that have already been rasterized. The rasterization stage 460 generates fragment data (i.e., coverage masks for each covered geometric primitive) that are transmitted to the pixel shader stage 470.

The pixel shader stage 470 processes fragment data by performing a set of operations (i.e., a fragment shader or a program) on each of the fragments. The pixel shader stage 470 may generate pixel data (i.e., color values) for the fragment such as by performing lighting operations or sampling texture maps using interpolated texture coordinates for the fragment. The pixel shader stage 470 generates pixel data that is transmitted to the raster operations stage 480. In one embodiment, the pixel shader stage 470 may access data generated by an upstream processing unit. For example, the pixel shader stage 470 may read per-patch attributes that were generated by the hull shader stage 425 and/or per-primitive attributes that were generated by the geometry shader stage 440. In one embodiment, the viewport stage 450 may be configured to compute additional attributes for clipped perspective corrected barycentric coordinates that are used by the pixel shader stage 470 to perform barycentric interpolation to compute per-sample or per-pixel attributes. In another embodiment, the pixel shader stage 470 may read per-patch control point attributes and compute the per-sample or per-pixel attributes.

The raster operations stage 480 may perform various operations on the pixel data such as performing alpha tests, stencil tests, and blending the pixel data with other pixel data corresponding to other fragments associated with the pixel. When the raster operations stage 480 has finished processing the pixel data (i.e., the output data 402), the pixel data may be written to a render target such as a frame buffer, a color buffer, or the like. The raster operations stage 480 may be configured to perform gamma adjustment operations to decode and/or encode one or more sets of digital video data.

It will be appreciated that one or more additional stages may be included in the graphics processing pipeline 400 in addition to or in lieu of one or more of the stages described above. Various implementations of the abstract graphics processing pipeline may implement different stages. Furthermore, one or more of the stages described above may be excluded from the graphics processing pipeline in some embodiments. Other types of graphics processing pipelines are contemplated as being within the scope of the present disclosure. Furthermore, any of the stages of the graphics processing pipeline 400 may be implemented by one or more dedicated hardware units within a graphics processor such as PPU 200. Other stages of the graphics processing pipeline 400 may be implemented by programmable hardware units such as the SM 250 of the PPU 200.

FIG. 5 illustrates an exemplary system 500 in which the various architecture and/or functionality of the various previous embodiments may be implemented. As shown, a system 500 is provided including at least one central processor 501 that is connected to a communication bus 502. The communication bus 502 may be implemented using any suitable protocol, such as PCI (Peripheral Component interconnect), PCI-Express, AGP (Accelerated Graphics Port), HyperTransport, or any other bus or point-to-point communication protocol(s). The system 500 also includes a main memory 504. Control logic (software) and data are stored in the main memory 504, which may take the form of random access memory (RAM).

The system 500 also includes input devices 512, a graphics processor 506, and a display 508, i.e. a conventional CRT (cathode ray tube), LCD (liquid crystal display), LED (light emitting diode), plasma display or the like. User input may be received from the input devices 512, e.g., keyboard, mouse, touchpad, microphone, and the like. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. Computer programs, or computer control logic algorithms, may be stored in the main memory 504 and/or the secondary storage 510. Such computer programs, when executed, enable the system 500 to perform various functions. The main memory 504, the storage 510, and/or any other storage are possible examples of computer-readable media.

In one embodiment, the architecture and/or functionality of the various previous figures may be implemented in the context of the central processor 501, the graphics processor 506, an integrated circuit (not shown) that is capable of at least a portion of the capabilities of both the central processor 501 and the graphics processor 506, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, laptop computer, server, workstation, game consoles, embedded system, and/or any other type of logic. Still yet, the system 500 may take the form of various other devices including, but not limited to a personal digital assistant (PDA) device, a mobile phone device, a television, etc.

Further, while not shown, the system 500 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
generating a logarithm space representation of an input value by computing a logarithm of the input value;
computing a logarithm space gamma-adjusted value by multiplying the logarithm space representation with a current gamma value; and
generating a gamma adjusted value by computing an antilogarithm of the logarithm space gamma-adjusted value.

2. The method of claim 1, wherein computing the logarithm comprises performing a look-up operation within a logarithm look-up table, indexed to a mantissa of the input value.

3. The method of claim 2, wherein the logarithm look-up table comprises a read-only look-up table circuit.

4. The method of claim 1, wherein computing the antilogarithm comprises performing a lock-up operation within one antilogarithm look-up table, indexed by the logarithm space gamma-adjusted value.

5. The method of claim 1, wherein computing the antilogarithm comprises:
generating two or more partial antilogarithm terms; and
computing a product over the two or more partial antilogarithm terms.

6. The method of claim 5, wherein generating each one of the two or more partial antilogarithm terms comprises performing a look-up table operation within a corresponding partial antilogarithm look-up table, indexed by at least a corresponding subset of fraction bits from the logarithm space gamma-adjusted value.

7. The method of claim 5, wherein each one of the two or more partial antilogarithm terms comprises a ten bit integer component and a ten bit fractional component.

8. The method of claim 1, wherein the input value comprises one color channel from either a red, green, or blue color channel associated with digital video data.

9. The method of claim 8, wherein the digital video data is encoded with an encoding gamma, and the current gamma value comprises a reciprocal of the encoding gamma.

10. The method of claim 8, wherein the digital video data comprises linear space color data, and the current gamma value comprises a gamma for a display device configured to display the digital video data.

11. The method of claim 1, wherein the input value comprises a floating-point representation and the current gamma value comprises a fixed-point representation.

12. A circuit, comprising:
a power function circuit, configured to compute a logarithm space gamma-adjusted value based on an input value and a current gamma value; and
an antilogarithm function circuit, configured to generate a gamma adjusted value based on the logarithm space gamma-adjusted value,
wherein the gamma adjusted value comprises an approximation of the input value raised to a power specified by the current gamma value, and
wherein the input value comprises a floating-point representation and the current gamma value comprises a fixed-point representation.

13. The circuit of claim 12, wherein the input value comprises a mantissa and an exponent, and the power function circuit comprises:
a logarithm lookup table, configured to generate a logarithm value based on the mantissa;
an adder, configured to compute a logarithm space representation of the input value by adding the logarithm value to the exponent; and
a multiplier, configured to compute the logarithm space gamma-adjusted value by multiplying the logarithm space representation by the current gamma value.

14. The circuit of claim 12, wherein the antilogarithm function comprises:
two or more antilogarithm lookup tables configured to generate corresponding partial antilogarithm terms based the logarithm space gamma-adjusted value; and
one or more multipliers configured to compute a product of partial antilogarithm terms, wherein each of the antilogarithm lookup tables is indexed by at least a corresponding subset of fraction bits from the logarithm space gamma-adjusted value.

15. A system, comprising:
a memory system configured to store video data; and
a graphics processor, configured to:
generate a first set of linear space video data from a first video stream comprising the video data, according to a first decoding gamma value;
generate a second set of linear space video data from a second video stream comprising the video data, according to a second decoding gamma value; and
generate a third set of linear space video data based on the first set of linear space video data and the second set of linear space video data,
wherein the first video stream is gamma-encoded by a gamma function circuit according to a first encoding gamma value, and the second video stream is gamma-encoded by the gamma function circuit according to a second encoding gamma value, and
wherein the gamma function circuit is configured to sequentially receive the first encoding gamma value and the second encoding gamma value.

16. The system of claim 15, wherein the gamma function circuit comprises:
a power function circuit, configured to compute a logarithm space gamma-adjusted value based on an input value and a current gamma value; and
an antilogarithm function circuit, configured to generate a gamma adjusted value based on the logarithm space gamma-adjusted value,
wherein the gamma adjusted value comprises an approximation of the input value raised to a power specified by the current gamma value.

17. The system of claim 16, wherein the input value comprises a mantissa and an exponent, and the power function circuit comprises:
a logarithm lookup table, configured to generate a logarithm value based on the mantissa;
an adder, configured to compute a logarithm space representation of the input value by adding the logarithm value to the exponent; and
a multiplier, configured to compute the logarithm space gamma-adjusted value by multiplying the logarithm space representation by the current gamma value.

18. The system of claim 16, wherein the antilogarithm function comprises:
two or more antilogarithm lookup tables configured to generate corresponding partial antilogarithm terms based the logarithm space gamma-adjusted value; and
one or more multipliers configured to compute a product of partial antilogarithm terms,
wherein each of the antilogarithm lookup tables is indexed by a sign bit and a range of mantissa bits comprising the logarithm space gamma-adjusted value.

19. The system of claim 15, wherein to generate the third set of linear space video data, the graphics processor performs at least one compositing operation on first set of linear space video data and the second set of linear space video data.

20. The system of claim 15, wherein the first decoding gamma value represents a reciprocal of the first encoding gamma value, and the second decoding gamma value represents a reciprocal of the second encoding gamma value.
